(19) United States
(12) Patent Application Publication
(10) Pub. No.: US 2025/0076169 A1
(43) Pub. Date: Mar. 6, 2025

(54) DEVICE AND METHOD FOR TESTING MECHANICAL PROPERTIES OF MATERIALS UNDER HIGH ROTATION SPEED AND HIGH TEMPERATURE

(71) Applicant: ZHEJIANG UNIVERSITY, Zhejiang (CN)

(72) Inventors: Hua WEI, Zhejiang (CN); Jianjiang ZHAO, Zhejiang (CN); Keman LIU, Zhejiang (CN); Weian LIN, Zhejiang (CN); Yunmin CHEN, Zhejiang (CN); Ze ZHANG, Zhejiang (CN)

(73) Assignee: ZHEJIANG UNIVERSITY, Zhejiang (CN)

(21) Appl. No.: 18/954,533

(22) Filed: Nov. 21, 2024

Related U.S. Application Data
(63) Continuation of application No. PCT/CN2023/082245, filed on Mar. 17, 2023.

(30) Foreign Application Priority Data
Feb. 6, 2023 (CN) 202310064627.2
Feb. 6, 2023 (CN) 202310064653.5

(51) Int. Cl. G01N 3/18; G01N 3/04; G05D 23/22

(52) U.S. Cl. CPC G01N 3/18; G05D 23/22; G01N 3/04; G01N 2203/0001; G01N 2203/0003; G01N 2203/0017; G01N 2203/0075; G01N 2203/0226; G01N 2203/0228; G01N 2203/0694

(57) ABSTRACT

The disclosure provides a device and a method for testing mechanical properties of a material under a high rotation speed and a high temperature. A sample chuck is installed on a main shaft of a centrifugal machine and rotates synchronously. A test sample is installed on the sample chuck. The induction heating system is installed on the centrifugal machine and does not rotate. The induction heating system is connected to a circulating water cooling system. A temperature controlling system is connected to the circulating water cooling system and the test sample. Parameters of the centrifugal machine, the test sample, etc. are determined. A temperature-controlling thermocouple and a strain gauge are installed on a standard section. A rotation speed of the centrifugal machine reaches the speed and is maintained until it breaks. Data is collected, and then the centrifugal machine is turned off and air-cooled to a room temperature.

### CROSS-REFERENCE TO RELATED APPLICATION

This application is a continuation of international application of PCT application serial no. PCT/CN2023/082245 filed on Mar. 17, 2023, which claims the priority benefit of China application no. 202310064653.5 and 202310064627.2, filed on Feb. 6, 2023. The entirety of each of the above mentioned patent applications is hereby incorporated by reference herein and made a part of this specification.

### BACKGROUND

### Technical Field

The disclosure relates to a device and a method for testing material properties in a field of testing mechanical properties of a metal material, and more particularly, to an in-situ heating testing device and a high-throughput testing method for the mechanical properties of the metal material under a high rotation speed and a high temperature.

### Description of Related Art

National standards, such as “Creep-Fatigue Test Methods for Metal Materials” of GB/T 38822-2020 and “Inspection of Static Uniaxial Testing Machines Part 1: Inspection and Calibration of Force Measuring Systems of Tensile and/or Compression Testing Machines” of GB/T6825.1-2008 all specify test methods for the mechanical properties of metal materials. On the one hand, test environments specified in the standards are all 1G (G=9.8 m/^{s}2), which may meet the research on the mechanical properties of the metal materials themselves. On the other hand, the testing standards may only test the mechanical properties of materials under one condition at a time, which results in low test efficiency and high cost. However, with implementation of the materials genome project and the two-machine special projects, as well as urgency of research and development tasks for key components of turbine propulsion systems such as aircraft engines, aerospace engines, industrial and ship gas turbines, automotive and train turbochargers, such as compressor blades, fan blades, turbine working blades, etc., especially materials of the system components are in a high-speed rotation state during normal operation, that is, a service environment is usually a centrifugal supergravity environment.

A turbine propulsion system is usually a turbine power device that converts heat energy after fuel combustion into mechanical energy through guide blades on the working blades through thermal expansion to drive a turbine. A turbocharger is a power device that converts waste heat of the engine into mechanical energy by utilizing thermal expansion of exhaust gas of a diesel (gasoline) engine on the turbine. When in service, the turbine blades of these power devices rotate at a high speed around an engine axis, and a function thereof is to expand combustion gas for power, converting potential energy and thermal energy of the combustion gas into mechanical power of a rotor. Therefore, loads borne by the turbine blades during service include aerodynamic force, centrifugal force, and thermal load. The centrifugal force generated by high-speed rotation is a volume force, which mainly causes radial tensile stress in the blades. For blades with torsional structures, torsional stress will also be generated. If a stacking line of the blade does not completely coincide with a radial line, the centrifugal force will also cause bending stress in the blades. Thermal stress generated by the thermal load is closely related to temperature gradients and geometric constraints of the blades. The greater the temperature gradients of the blades, the greater the thermal stress.

However, data of mechanical properties of key materials currently used to design the turbine blades of the turbine propulsion systems all come from endurance, creep, fatigue, and other testing machines under 1G conditions, which obtain the data of mechanical properties of materials under static, uniaxial stress states by testing standard specimens. Although the data of the mechanical properties of the standard specimens may provide a design basis for a strength design of turbine blades in the turbine propulsion systems to a certain extent, due to a complex geometric shape of the blades and a complex stress state thereof being different from those of the standard specimens, the data of the material mechanical properties obtained by the standard specimens do not take into account the impact of high rotation speed, blade geometry, etc. on structural reliability thereof and may not be directly used to evaluate the service life of turbine blades.

### SUMMARY

In view of shortcomings of the current static mechanical property testing of metal materials under 1G, the lack of in-situ heating devices and intelligent temperature controlling technologies suitable for the mechanical property testing of metal materials under a high rotation speed and a high temperature, and the urgent need for high-throughput mechanical property testing of metal materials in the research and development of new materials, the disclosure provides a device that may apply in-situ heating to metal materials in a high-speed rotation environment and a method based on the in-situ heating device that is suitable for the high-throughput mechanical property testing of the metal materials under high-rotation speed and high-temperature effects, which solves key issues of in-situ heating and temperature control in the mechanical property testing of the metal materials under a high rotation speed and a high temperature, and solves the current issues of low efficiency and high cost of the mechanical property testing of the metal materials, which is a device that may apply in-situ heating to the metal materials in a the-speed rotation environment and intelligent temperature control, and a high-throughput testing method for the mechanical properties of the metal materials.

The in-situ heating of the metal materials in the high-speed rotation environment described in the disclosure means that during the mechanical property testing of the metal material or component, the high-speed rotating test material or component is always in an in-situ heating state until the test is completed.

The high temperature described in the disclosure means that a heating temperature applied to a designated area of a sample during the experiment is not less than 500° C., and the duration of the in-situ heating is not less than the test time.

The high rotation speed described in the disclosure means that a maximum rotation speed of the centrifugal machine during the experiment is not less than 5000 rpm.

The high throughput described in the disclosure means that in a single experiment, the materials tested in a single experiment (1) have no less than 10 stress states under the same temperature conditions; (2) have no less than 5 temperatures under the condition that the stress gradient remains unchanged.

Technical solutions adopted in the disclosure:

1. An in-situ heating testing device for mechanical properties of a metal material under a high rotation speed and a high temperature:

The device includes a sample chuck, an induction heating system, a circulating water cooling system, and a temperature controlling system; the sample chuck is coaxially installed on a main shaft of a centrifugal machine and rotates synchronously around the main shaft of the centrifugal machine, the test sample is installed on the sample chuck, the induction heating system is coaxially installed on the centrifugal machine and does not rotate around the main shaft of the centrifugal machine, the induction heating system is connected to the circulating water cooling system, and the temperature controlling system is connected to the circulating water cooling system and the test sample respectively.

The sample chuck includes a disc body, a slot, and a flange, the flange is coaxially installed at two ends of a center of the disc body, the disc body is coaxially fixedly connected to the main shaft of the centrifugal machine through the flange, multiple slots are circumferentially disposed around the disc body, the slots are arranged at intervals along a circumferential direction, and each of the slots is used to install the one test sample.

The test sample is in a strip shape, including a mass block, a standard section, a load-bearing section, and an assembly tenon connected in sequence, the mass block, the standard section, the load-bearing section, and the assembly tenon are arranged in sequence along the strip shape of the test sample, and the assembly tenon is embedded in the slot of the sample chuck.

One or both of a thermocouple and a strain gauge are arranged at a center of the standard section of the test sample.

The induction heating system includes an upper induction coil, an upper fixing plate, a lower induction coil, and a lower fixing plate; the upper fixing plate and the lower fixing plate are respectively fixed and arranged in parallel at upper and lower intervals, and the sample chuck is arranged in an interval between the upper fixing plate and the lower fixing plate; the annular upper induction coil and lower induction coil are respectively fixed to a bottom surface of the upper fixing plate and a top surface of the lower fixing plate through the upper induction coil insulation layer and the lower induction coil insulation layer.

The upper induction coil and the lower induction coil are respectively wrapped in inner cavities of the upper induction coil insulation layer and the lower induction coil insulation layer, the inner cavities of the upper induction coil insulation layer and the lower induction coil insulation layer are communicated through a pipeline, and the upper induction coil insulation layer and the lower induction coil insulation layer are respectively fixed to the bottom surface of the upper fixing plate and the top surface of the lower fixing plate through an upper fixing screw rod and a lower fixing screw rod.

The circulating water cooling system includes a pipeline assembly arranged in the induction heating system and a circulating water inlet pipe, a circulating water outlet pipe, a positive electrode, an inner insulation sleeve, a metal sleeve, a negative electrode, a copper tube, an insulating pressing sleeve, a fixing flange, an insulating pressing sleeve, a tightening round nut, a sealing member, an electrode insulating pressing sleeve, an external water outlet pipe, an external positive electrode plate, an external water inlet pipe, and an external negative electrode plate; the copper tube is sleeved with an insulating pressing sleeve for insulation from the metal sleeve, and the insulating pressing sleeve is sleeved with the metal sleeve; a middle portion of the metal sleeve is sealed and sleeved in a center hole of the fixing flange through an insulating pressing sleeve and a shaft sealing ring, the fixing flange is fixed on an experimental chamber cover of the centrifugal machine, the copper tube, two ends of the insulating pressing sleeve, and the metal sleeve are respectively fixed and sealed through the inner insulation sleeve and the sealing member; one end of the copper tube passes through the inner insulation sleeve to be coaxially connected to the circulating water outlet pipe, and the positive electrode is arranged at an end portion after one end of the copper tube passes through the inner insulation sleeve; the external positive electrode plate is electrically connected to the copper tube through the electrode insulating pressing sleeve, so that the positive electrode is directly electrically connected to the external positive electrode plate through the copper tube; the other end of the copper tube is connected to the external water outlet pipe, so that the circulating water outlet pipe circulates directly through the copper tube and the external water outlet pipe; an annular pipe gap is provided between the insulating pressing sleeve and the metal sleeve for use as a water inlet channel, one end of the water inlet channel is communicated and connected to the circulating water inlet pipe through a metal pipe, the negative electrode is disposed near an end of the circulating water inlet pipe; the external negative electrode plate is electrically connected to the metal sleeve through the tightening round nut, so that the negative electrode is electrically connected to the external negative electrode plate through the metal pipe and the metal sleeve in sequence; a through groove is disposed on one end of a pipe wall of the metal sleeve connected to the sealing member, and the through groove is in fluid communication with the external water inlet pipe, so that the circulating water inlet pipe is in fluid communication with the external water inlet pipe through the metal pipe, the water inlet channel, and the through groove.

The pipeline assembly includes a heating water inlet pipe, a water inlet pipe sealing sleeve, a heating water outlet pipe, and a water outlet pipe sealing sleeve; one ends of the heating water inlet pipe and the heating water outlet pipe are connected to the circulating water inlet pipe and the circulating water outlet pipe through the water inlet pipe sealing sleeve and the water outlet pipe sealing sleeve respectively, the other ends of the heating water inlet pipe and the heating water outlet pipe are respectively connected to inner cavity environments where the upper induction coil and the lower induction coil in the induction heating system are located, and the inner cavity environments where the upper induction coil and the lower induction coil are located are connected to each other.

The external water outlet pipe and the external water inlet pipe are respectively connected to a water inlet and a water outlet of a circulating water machine; the positive electrode and the negative electrode are electrically connected to the upper induction coil and the lower induction coil respectively, and the external positive electrode plate and the external negative electrode plate are connected to positive and negative electrodes of an external power source respectively.

The temperature controlling system includes a thermocouple, a thermocouple extension wire, a high-speed slip ring, a data acquisition module, a data conversion and transmission module, and a high-frequency AC power supply cabinet; the thermocouple is fixedly disposed on a surface of the test sample corresponding to the upper induction coil and the lower induction coil of the induction heating system, the thermocouple is connected to the data acquisition module through the thermocouple extension wire and the high-speed slip ring, the data acquisition module is communicatively connected to the high-frequency AC power supply cabinet through the data conversion transmission module, and the high-frequency AC power supply cabinet is electrically connected to the external positive electrode plate and the external negative electrode plate of the circulating water cooling system.

2. A method based on the in-situ heating device that is suitable for the high-throughput mechanical property testing of the metal materials under high-rotation speed and high-temperature effects.
first step: determining a spindle speed and a wheel radius of the centrifugal machine according to experimental conditions;
second step: determining a size and a weight of the mass block in the test sample, and a size and a geometric center of the standard section;
third step: determining a test temperature and centrifugal stress applied at the geometric center of the standard section, and then determining a rotation speed corresponding to the centrifugal stress at the geometric center of the standard section;
fourth step: installing the test sample in the slot of the sample chuck, and determining a distance between the geometric center of the standard section and a center of the main shaft of the centrifugal machine;
fifth step: fixing the upper temperature-controlling thermocouple at the geometric center of the standard section of the test sample;
fixing a strain gauge at the geometric center of the standard section of the test sample, and connecting the strain gauge to the data acquisition module through a strain gauge extension wire;
sixth step: starting the induction heating system, the circulating water cooling system, and the temperature controlling system, and through the temperature controlling system, controlling the induction heating system and the circulating water cooling system to apply a temperature load to the test sample;
seventh step: when the temperature reaches a set temperature, starting the centrifugal machine such that the main shaft of the centrifugal machine rotates and the rotation speed reaches a set rotation speed condition;
eighth step: keeping the temperature and the rotation speed unchanged until the test sample is pulled and broken;
during a process from when the main shaft of the centrifugal machine starts to rotate to when the test sample is pulled and broken, data of temperature changes and stress changes are collected in real time through the temperature-controlling thermocouple and the strain gauge as data for the high-throughput testing to obtain curves of temperature vs. time and strain vs. time in a process of high-throughput mechanical property testing of a material;
ninth step: after the test sample is pulled and broken, turning off the induction heating system and the temperature controlling system, powering off the centrifugal machine, and air-cooling the test sample to a room temperature.

In the sixth step, the induction heating system is started to apply the temperature load to the test sample, specifically, a constant and uniform temperature field is applied according to a uniform temperature heating mode, a periodically changing alternating temperature field is applied according to a periodically changing alternating temperature heating mode, and a temperature field with a fixed range and a gradually changing gradient is applied according to a temperature gradient heating mod.

In the seventh step, the centrifugal machine is started to rotate the main shaft of the centrifugal machine, specifically, the rotation speed is adjusted, so that different centrifugal tensile stress is applied to different positions of the test sample along a direction of the centrifugal force, or a constant stress oi load is applied to different positions of the test sample along the direction of the centrifugal force.

In the seventh step, the centrifugal machine is started to rotate the main shaft of the centrifugal machine, and the rotation speed reaches a fixed rotation speed corresponding to the centrifugal stress.

Beneficial effects of the disclosure are:

(1) The disclosure solves the current limitation that a radiation heating temperature may not exceed 800° C. at a high rotation speed, and the disclosure may increase a partial heating temperature of the test component to 1200° C. at a high rotation speed.

The disclosure solves the current technical limitation that radiation heating may not achieve rapid temperature alternation at a high rotation speed, and the disclosure may control the induction heating power through a program at a high rotation speed to apply a constant or alternating temperature load to the test component.

(3) At present, conventional laboratory performance tests may only test the mechanical properties of one material under one condition at a time, and the test efficiency is low. The disclosure will provide a material mechanical property test of multiple materials under one condition at a time, which greatly facilitates the comparative test of the mechanical properties of different materials under the same test conditions and greatly improves the efficiency of material property testing.

### BRIEF DESCRIPTION OF THE DRAWINGS

FIG. 1 is a schematic diagram of a structure of a sample chuck 1.

FIG. 2 is a schematic diagram of a structure of a test sample 1.1.

FIG. 3 is a schematic diagram of a structure of an induction heating system 2.

FIG. 4 is a schematic diagram of a structure of a circulating water cooling system 3.

FIG. 5 is a schematic diagram of a temperature controlling system 4.

FIG. 6 is a schematic diagram of the structure of the test sample 1.1.

FIG. 7 is a schematic diagram of the structure of the test sample 1.1.

FIG. 8 is a schematic diagram of the structure of the test sample 1.1.

FIG. 9 is a schematic diagram of installation of the sample chuck 1 and the induction heating system 2 on a centrifugal machine.

FIG. 10 is a process routing diagram of heating in the first specific embodiment.

FIG. 11 is a process routing diagram of heating in the second specific embodiment.

FIG. 12 is a process routing diagram of heating in the third specific embodiment.

FIG. 13 is a diagram of a high-throughput test scheme for the first type of mechanical properties.

FIG. 14 is a diagram of a high-throughput test scheme for the second type of mechanical properties.

FIG. 15 is a diagram of a high-throughput test scheme for the third type of mechanical properties.

In the drawings:
the sample chuck 1: the test sample 1.1, a slot 1.2, and a flange 1.3;
a mass block 1.1.1, a standard section 1.1.2, a load-bearing section 1.1.3, an assembly tenon 1.1.4;
the induction heating system 2: an upper induction coil 2.1, an upper induction coil insulation layer 2.2, an upper fixing plate 2.3, an upper fixing screw rod 2.4, a lower induction coil 2.5, a lower induction coil insulation layer 2.6, a lower fixing plate 2.7, a lower fixing screw rod 2.8, a connecting rod 2.9, a nut 2.10, a heating water inlet pipe 2.11, a water inlet pipe sealing sleeve 2.12, a heating water outlet pipe 2.13, a water outlet pipe sealing sleeve 2.14;
the circulating water cooling system 3: a circulating water inlet pipe 3.1, a connecting nut 3.2, a circulating water outlet pipe 3.3, a connecting nut 3.4, a positive electrode 3.5, an inner insulation sleeve 3.6, a negative electrode 3.8, a copper tube 3.9, an insulating pressing sleeve 3.10, a fixing flange 3.11, a fixing screw rod 3.12, a shaft sealing ring 3.13, an insulating pressing sleeve 3.14, a tightening round nut 3.15, a tightening nut 3.16, an insulation member 3.17, a sealing member 3.18, an electrode insulating pressing sleeve 3.19, a sealing nut 3.20, an external water outlet pipe 3.21, an external positive electrode plate 3.22, an external water inlet pipe 3.23, and an external negative electrode plate 3.24;
the temperature controlling system 4: a thermocouple 4.1, a thermocouple extension wire 4.2, a high-speed slip ring 4.3, a data acquisition module 4.4, a control software 4.5, a data conversion and transmission module 4.6, a high-frequency AC power supply cabinet 4.7.

### DETAILED DESCRIPTION OF DISCLOSED EMBODIMENTS

The disclosure is further described below with reference to the accompanying drawings and specific embodiments.

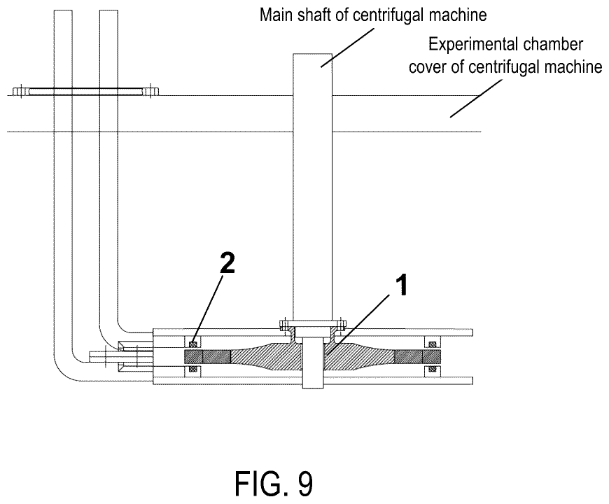

As shown in FIG. 9, a high-throughput testing device is specifically designed and implemented, and the device includes a sample chuck 1, an induction heating system 2, a circulating water cooling system 3, and a temperature controlling system 4. The sample chuck 1 is coaxially installed on a main shaft of a centrifugal machine and rotates synchronously around the main shaft of the centrifugal machine. The test sample 1.1 is installed on the sample chuck 1. The induction heating system 2 is coaxially installed on the centrifugal machine and does not rotate around the main shaft of the centrifugal machine but remains fixed. The induction heating system 2 is connected to the circulating water cooling system 3. The temperature controlling system 4 is respectively connected to the circulating water cooling system 3 and the test sample 1.1.

The specific implemented centrifugal machine is a supergravity centrifugal machine.

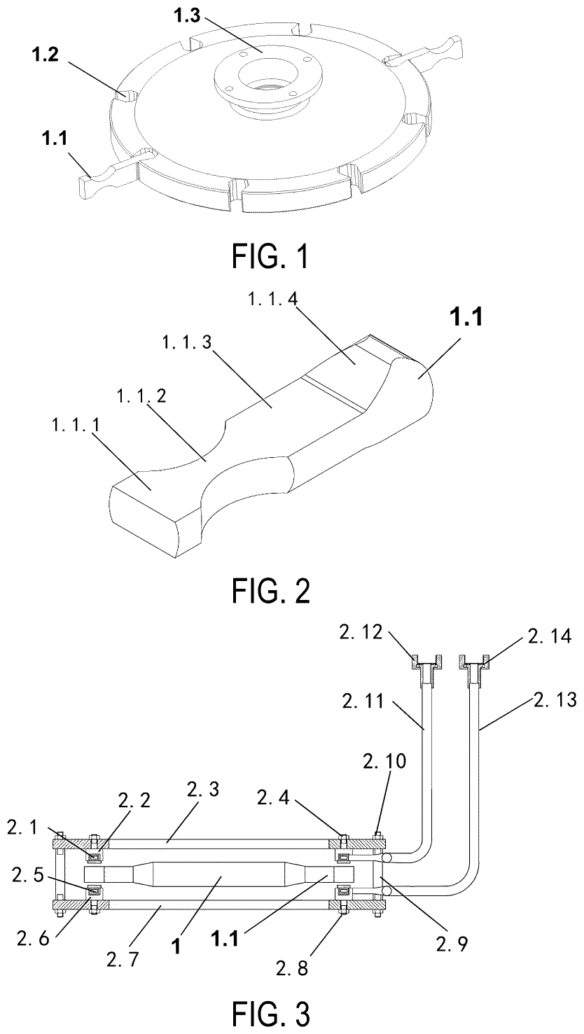

As shown in FIG. 1, a function of the sample chuck 1 is used to install the test sample and is connected to the centrifugal machine through the main shaft. It includes a disc body, a slot 1.2, and a flange 1.3. The flanges 1.3 are coaxially fixedly installed at two ends of a center of the disc body. The disc body is coaxially fixedly connected to the main shaft of the centrifugal machine through the flange 1.3. Multiple slots 1.2 are disposed around the disc body along a circumferential direction. The slots 1.2 are arranged at intervals along the circumferential direction, and each of the slots 1.2 is used to install one test sample 1.1.

The flange 1.3 is used to connect the sample chuck 1 to the main shaft of the centrifugal machine. During an experiment, the main shaft of the centrifugal machine rotates at a high speed to drive the sample chuck 1 to rotate, thereby applying centrifugal load to the test sample 1.1.

The slot 1.2 is mainly used to fix the test sample 1.1 rotating at a high speed. An assembly tenon 1.1.4 of the test sample 1.1 is installed in the slot 1.2, so that the sample chuck 1 drives the test sample 1.1 to rotate together when rotating.

As shown in FIG. 2, the test sample 1.1 is made of a metal material for testing properties and is in a strip shape, including a mass block 1.1.1, a standard section 1.1.2, a load-bearing section 1.1.3, and the assembly tenon 1.1.4 which are connected in sequence. The mass block 1.1.1, the standard section 1.1.2, the load-bearing section 1.1.3, and the assembly tenon 1.1.4 are arranged in sequence along the strip shape of the test sample 1.1. Specifically, the mass block 1.1.1, the standard section 1.1.2, the load-bearing section 1.1.3, and the assembly tenon 1.1.4 are arranged in sequence radially outward from the slot 1.2 of the sample chuck 1, and the assembly tenon 1.1.4 is embedded in the slot 1.2 of the sample chuck 1.

In the specific embodiment, a width of the assembly tenon 1.1.4 and a width of the slot 1.2 of the sample chuck 1 are both greater than widths of the mass block 1.1.1, the standard section 1.1.2, and the load-bearing section 1.1.3, so that the test sample 1.1 may be stably embedded and positioned when it is driven by the sample chuck 1 to rotate at a high speed.

The mass block 1.1.1 is used to apply centrifugal stress to the standard section 1.1.2 through centrifugal force generated by its own weight at a high rotation speed. Mass of the mass block 1.1.1 is m, an effective radius is r, and a rotation speed is ω. Then, the centrifugal force generated by the mass block 1.1.1 is F=mrω². The weight m of the mass block 1.1.1 depends on the fracture strength of the material under experimental conditions.

The standard section 1.1.2 is connected to the mass block 1.1.1, and is used to bear the centrifugal stress and thermal stress loads applied by the mass block 1.1.1 under the high-speed rotation and high temperature. A shape of the standard section 1.1.2 may be changed according to actual requirements.

The load-bearing section 1.1.3 is used to connect the standard section 1.1.2 to the assembly tenon 1.1.4.

According to experimental requirements, the test sample 1.1 may be designed with structures as shown in FIGS. 2 and 6 to 8.

One or both of a thermocouple and a strain gauge are arranged at a center of the standard section 1.1.2 of the test sample 1.1.

As shown in FIG. 3, a function of the induction heating system 2 is to heat a high-speed rotating sample in situ and apply a temperature load to a specified area of the test sample 1.1. It includes an upper induction coil 2.1, an upper fixing plate 2.3, a lower induction coil 2.5, and a lower fixing plate 2.7. The upper fixing plate 2.3 and the lower fixing plate 2.7 are respectively fixed and arranged in parallel at upper and lower intervals. In the specific embodiment, the main shaft of the centrifugal machine is rotatably arranged to pass through the upper fixing plate 2.3. The sample chuck 1 is arranged in an interval between the upper fixing plate 2.3 and the lower fixing plate 2.7. The upper fixing plate 2.3 and the lower fixing plate 2.7 are supported and fixed by a connecting rod 2.9, and a nut 2.10 is arranged at an outer end of the connecting rod 2.9 for installation. The annular upper induction coil 2.1 and the lower induction coil 2.5 are fixed to a bottom surface of the upper fixing plate 2.3 and a top surface of the lower fixing plate 2.7 through the upper induction coil insulation layer 2.2 and the lower induction coil insulation layer 2.6 respectively.

The upper fixed plate 2.3 and the lower fixed plate 2.7 are both annular plates, and the upper induction coil 2.1 and the lower induction coil 2.5 are both integral annular coils.

Specifically, the upper induction coil 2.1 and the lower induction coil 2.5 are respectively wrapped in inner cavities of the upper induction coil insulation layer 2.2 and the lower induction coil insulation layer 2.6. The inner cavities of the upper induction coil insulation layer 2.2 and the lower induction coil insulation layer 2.6 are communicated through a pipeline. The upper induction coil insulation layer 2.2 and the lower induction coil insulation layer 2.6 are respectively fixed to the bottom surface of the upper fixing plate 2.3 and the top surface of the lower fixing plate 2.7 through an upper fixing screw rod 2.4 and a lower fixing screw rod 2.8.

The upper induction coil 2.1 is wrapped inside the upper induction coil insulation layer 2.2 to prevent conduction and is used for insulation. Then, the upper induction coil 2.1 with an insulation layer is fixed to the upper fixing plate 2.3 through the upper fixing screw rod 2.4 to form the upper induction coil. The lower induction coil 2.5 is wrapped inside the lower induction coil insulation layer 2.6, and the lower induction coil 2.5 with an insulation layer is also fixed to the lower fixing plate 2.7 through the lower fixing screw rod 2.8 to form the lower induction coil. subsequently, the upper fixing plate 2.3 and the lower fixing plate 2.7 are assembled together through the connecting rod 2.9 and the nut 2.10.

When an alternating current is applied, the metal material placed between the upper induction coil 2.1 and the lower induction coil 2.5 generates an induction current I (or an eddy current) under an alternating magnetic field effect. The eddy current generates heat through a conductor with resistance, and heats the metal material by heat conduction. The Joule heat generated by the induction current I is Q=I²Rt (R is the resistance of the metal material, and t is time). During an induction heating process, a heating temperature is controlled by adjusting an AC frequency f, a distance between the sample and the upper induction coil 2.1 and the lower induction coil 2.5 in a sample distance, and heating power.

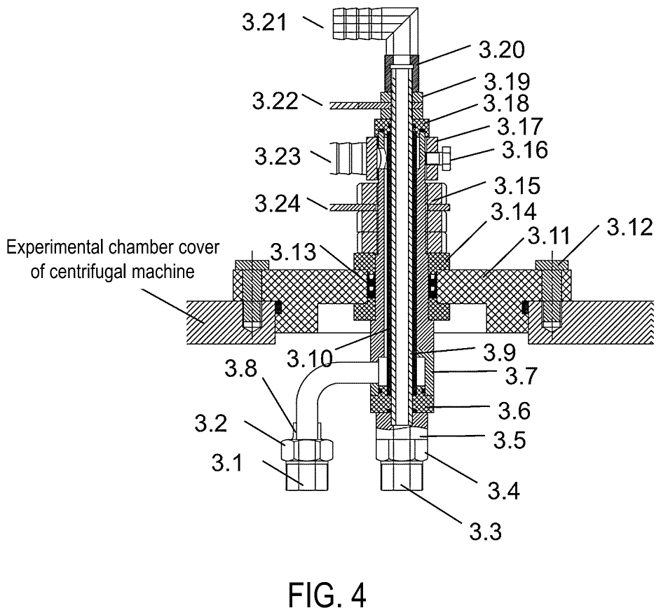

As shown in FIG. 4, a function of the circulating water cooling system 3 is to cool copper tubes in the upper induction coil 2.1 and the lower induction coil 2.5 in the induction heating system 2. It includes a pipeline assembly arranged in the induction heating system 2, and a circulating water inlet pipe 3.1, a circulating water outlet pipe 3.3, a positive electrode 3.5, an inner insulation sleeve 3.6, a metal sleeve 3.7, a negative electrode 3.8, a copper tube 3.9, an insulating pressing sleeve 3.10, a fixing flange 3.11, an insulating pressing sleeve 3.14, a tightening round nut 3.15, a sealing member 3.18, an electrode insulating pressing sleeve 3.19, an external water outlet pipe 3.21, an external positive electrode plate 3.22, an external water inlet pipe 3.23, and an external negative electrode plate 3.24.

The copper tube 3.9 is coaxially sleeved with the insulating pressing sleeve 3.10 and the metal sleeve 3.7 in sequence radially outward from the outside. The copper tube 3.9 is fixedly coaxially sleeved with the insulating pressing sleeve 3.10 for insulation from the metal sleeve 3.7. The insulating pressing sleeve 3.10 is coaxially sleeved with the metal sleeve 3.7 outside. In this way, the copper tube 3.9 and the metal sleeve 3.7 are kept insulated. A middle portion of the metal sleeve 3.7 is sealed in a center hole of the fixing flange 3.11 through the insulating pressing sleeve 3.14 and the shaft sealing ring 3.13. The fixing flange 3.11 is fixed to an experimental chamber cover of the centrifugal machine through the fixing screw rod 3.12. Two ends of the copper tube 3.9, the insulating pressing sleeve 3.10, and the metal sleeve 3.7 are fixed and sealed for installation respectively through the inner insulation sleeve 3.6 and the sealing member 3.18, and the inner insulation sleeve 3.6 and the sealing member 3.18 are used for insulation and water leakage prevention.

One end of the copper tube 3.9 passes through the inner insulation sleeve 3.6 and is coaxially connected to the water outlet pipe 3.3, and the positive electrode 3.5 is provided at an end portion after one end of the copper tube 3.9 passes through the inner insulation sleeve 3.6. The external positive electrode plate 3.22 is electrically connected to the copper tube 3.9 through multiple electrode insulating pressing sleeves 3.19. Specifically, at least two of the electrode insulating pressing sleeves 3.19 are threadedly installed on external threads of the copper tube 3.9. The external positive electrode plate 3.22 is compressed and installed between the two adjacent electrode insulating pressing sleeves 3.19, and the external positive electrode plate 3.22 passes through a gap between the two adjacent electrode insulating pressing sleeves 3.19 and maintains electrical connection with the external positive electrode plate 3.22. In this way, the positive electrode 3.5 is directly electrically connected to the external positive electrode plate 3.22 through the copper tube 3.9.

The other end of the copper tube 3.9 is connected to the external water outlet pipe 3.21 through the sealing nut 3.20, so that the water outlet pipe 3.3 circulates directly through the copper tube 3.9 and the external water outlet pipe 3.21.

There is an annular pipe gap between the insulating pressing sleeve 3.10 and the metal sleeve 3.7 for use as a water inlet channel. The water inlet channel is communicated and connected to the circulating water inlet pipe 3.1 through a metal pipe at one end close to the inner insulation sleeve 3.6. The negative electrode 3.8 is disposed near an end portion of the circulating water inlet pipe 3.1. The external negative electrode plate 3.24 is electrically connected to the metal sleeve 3.7 through multiple tightening round nuts 3.15. Specifically, at least two of the tightening round nuts 3.15 are threadedly installed on external threads of the metal sleeve 3.7. The external negative electrode plate 3.24 is compressed and installed between the two adjacent tightening round nuts 3.15. The external negative electrode plate 3.24 passes through a gap between the two adjacent tightening round nuts 3.15 and maintains electrical connection with the external negative electrode plate 3.24. In this way, the negative electrode 3.8 is electrically connected to the external negative electrode plate 3.24 through the metal pipe and the metal sleeve 3.7 in sequence.

A through groove is disposed on one end of a pipe wall of the metal sleeve 3.7, which is connected to the sealing member 3.18 and disposed between the external positive electrode plate 3.22 and the external negative electrode plate 3.24. The through groove is in fluid communication with the external water inlet pipe 3.23. Specifically, the metal sleeve 3.7 around the through groove is sleeved with the insulation member 3.17 through the tightening nut 3.16. The external water inlet pipe 3.23 passes through a through hole on the insulation member 3.17 to be communicated to the through groove. In this way, the water inlet pipe 3.1 is in fluid communication with the external water inlet pipe 3.23 through the metal pipe, the water inlet channel, and the through groove in sequence.

More specifically, the copper tube 3.9 is a long hollow copper tube. The insulating pressing sleeve 3.10 is installed on an outer periphery for insulation, and a sealing ring is installed to prevent air leakage in an experimental cavity.

The circulating water inlet pipe 3.1 is connected to the heating water inlet pipe 2.11 of the induction heating system 2 through the connecting nut 3.2. The circulating water outlet pipe 3.3 is connected to the heating water outlet pipe 2.13 of the induction heating system 2 through the connecting nut 3.4. The positive electrode 3.5 is installed on an outer periphery of the circulating water outlet pipe 3.3 to ensure that the cooling water may cool the positive electrode 3.5. The negative electrode 3.8 is installed on an outer periphery of the circulating water inlet pipe 3.1 to ensure that the cooling water may cool the negative electrode 3.8.

The metal sleeve 3.7 is installed on a chamber cover of the experimental chamber through the flange 3.11 with 6 fixing screw rods 3.12. Then, air leakage is prevented through the shaft sealing ring 3.13, and the insulating pressing sleeve 3.14 is used for insulation to prevent electric leakage. The external negative electrode plate 3.24 is fixedly installed on the insulating pressing sleeve 3.14 by three tightening round nuts 3.15. The external water inlet pipe 3.23 is communicated to the through groove of the copper tube 3.9 through the tightening nut 3.16 and the insulation member 3.17, and the external water inlet pipe 3.23 is easily replaced or repaired through the tightening nut 3.16. The insulation member 3.17 prevents the motor from leaking electricity. On the sealing member 3.18, the external positive electrode plate 3.22 is fixed through the electrode insulating pressing sleeve 3.19. On the electrode insulating pressing sleeve 3.19, the external water outlet pipe 3.21 is communicated to a copper pipe of the water outlet pipe 3.3 through the sealing nut 3.20.

The pipeline assembly includes the heating water inlet pipe 2.11, the water inlet pipe sealing sleeve 2.12, the heating water outlet pipe 2.13, and the water outlet pipe sealing sleeve 2.14. One ends of the heating water inlet pipe 2.11 and the heating water outlet pipe 2.13 are connected to the circulating water inlet pipe 3.1 and the circulating water outlet pipe 3.3 respectively through the water inlet pipe sealing sleeve 2.12 and the water outlet pipe sealing sleeve 2.14, and the other ends of the heating water inlet pipe 2.11 and the heating water outlet pipe 2.13 are respectively connected to inner cavity environments where the upper induction coil 2.1 and the lower induction coil 2.5 in the induction heating system 2 are located. The inner cavity environments where the upper induction coil 2.1 and the lower induction coil 2.5 are located is communicated to each other.

Specifically, the other end of the heating water inlet pipe 2.11 is connected to the circulating water inlet pipe 3.1 through the water inlet pipe sealing sleeve 2.12 and the connecting nut 3.2, and the other end of the heating water outlet pipe 2.13 is connected to the circulating water outlet pipe 3.3 through the water outlet pipe sealing sleeve 2.14 and the connecting nut 3.4.

The external water outlet pipe 3.21 and the external water inlet pipe 3.23 are respectively connected to a water inlet and an outlet of a circulating water machine. In the specific embodiment, the external water outlet pipe 3.21 is connected to a water inlet pipe of the circulating water machine, and the external water inlet pipe 3.23 is connected to a water outlet pipe of the circulating water machine, forming a closed circulating water cooling system to cool the induction heating system 2.

The positive electrode 3.5 and the negative electrode 3.8 are electrically connected to the upper induction coil 2.1 and the lower induction coil 2.5 respectively, and the external positive electrode plate 3.22 and the external negative electrode plate 3.24 are connected to positive and negative poles of an external power supply respectively. In the specific embodiment, the external positive electrode plate 3.22 is connected to a positive pole of the high-frequency AC power supply cabinet 4.7 as an AC power source, and the external negative electrode plate 3.24 is connected to a negative pole of the high-frequency AC power supply cabinet 4.7 as an AC power source, forming a closed-loop circuit to provide power to the induction heating system 2.

The inner cavity where the upper induction coil 2.1 is located is connected to the heating water inlet pipe 2.11, and the heating water inlet pipe 2.11 is connected to the circulating water inlet pipe 3.1 of the circulating water cooling system 3 through the water inlet pipe sealing sleeve 2.12. The inner cavity where the lower induction coil 2.5 is located is connected to the heating water outlet pipe 2.13. The heating water outlet pipe 2.13 is connected to the circulating water outlet pipe 3.3 of the circulating water cooling system 3 through the water outlet pipe sealing sleeve 2.14, and the cooling water provided through the cooling system 3 cools the copper tube.

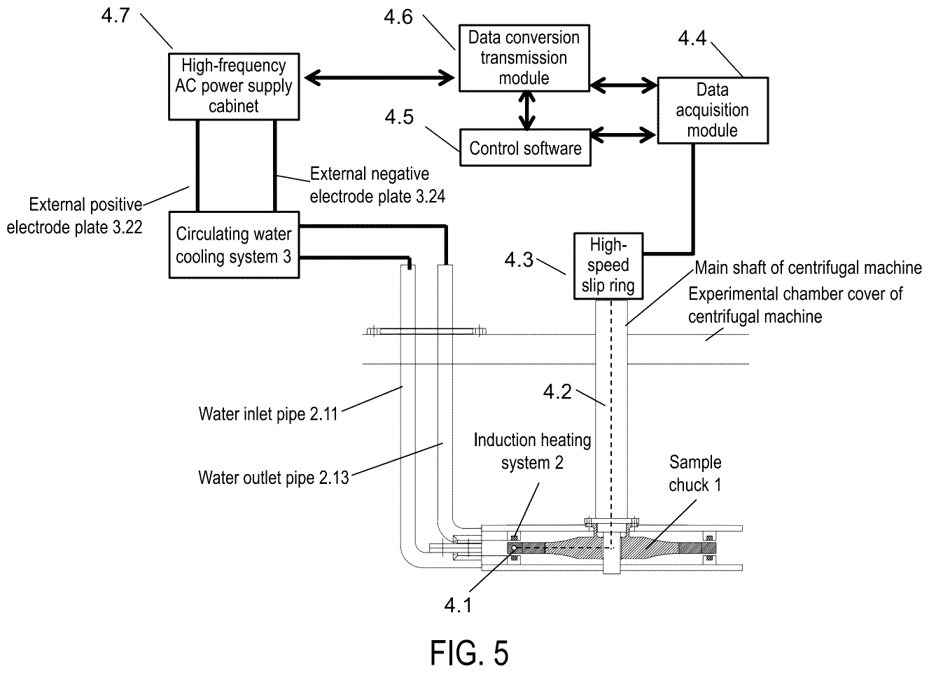

As shown in FIG. 5, a function of the temperature controlling system 4 is to ensure that the test sample 1.1 is heated to a predetermined temperature and maintained at the temperature until the end of the experiment by controlling the heating power of the induction power supply. It includes a thermocouple 4.1, a thermocouple extension wire 4.2, a high-speed slip ring 4.3, a data acquisition module 4.4, a data conversion and transmission module 4.6, and a high-frequency AC power supply cabinet 4.7. The thermocouple 4.1 is fixedly disposed on a surface of the test sample 1.1 corresponding to the upper induction coil 2.1 and the lower induction coil 2.5 of the induction heating system 2. The thermocouple 4.1 is connected to the data acquisition module 4.4 through the thermocouple extension wire 4.2 and a high-speed slip ring 4.3. The thermocouple extension wire 4.2 passes through the disc body of the sample chuck 1 and the main shaft of the centrifugal machine to be electrically connected to the high-speed slip ring 4.3. The high-speed slip ring 4.3 is arranged on the main shaft of the centrifugal machine. The data acquisition module 4.4 is communicatively connected to the high-frequency AC power supply cabinet 4.7 through the data conversion and transmission module 4.6, and the high-frequency AC power supply cabinet 4.7 is electrically connected to the circulating water machine as well as the external positive electrode plate 3.22 and the external negative electrode plate 3.24 of the circulating water cooling system 3.

In the specific embodiment, a control software 4.5 is further disposed, and the control software 4.5 is connected to the data acquisition module 4.4 and the data conversion and transmission module 4.6 respectively.

During the experiment, the thermocouple 4.1 is welded to a center of the test sample 1.1 corresponding to the upper induction coil 2.1 and the lower induction coil 2.5. Then, the thermocouple 4.1 is connected to the high-speed slip ring 4.3 through the hollow main shaft of the centrifugal machine through the thermocouple extension wire 4.2, and then connected to the data acquisition module 4.4, the control software 4.5, and the data conversion and transmission module 4.6 through a conducting wire. Finally, a control signal line is connected to the high-frequency AC power supply cabinet 4.7 to form a temperature controlling system.

In the disclosure, different samples are further designed to better test the mechanical properties of metal materials of the samples.

A structure of the first type of test sample 1.1, referring to FIG. 2, is a groove sample and related similar structures thereof.

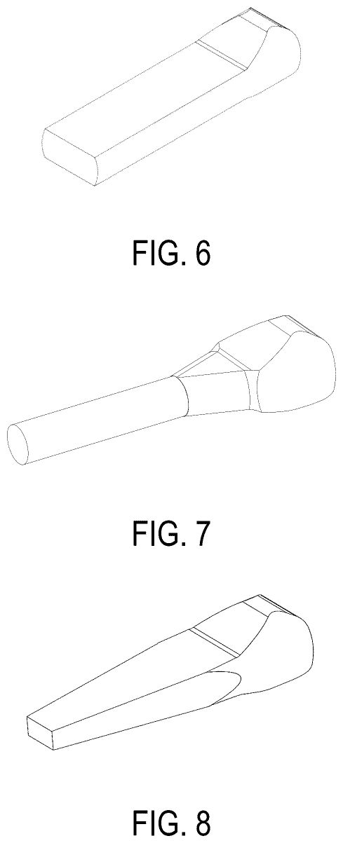

A structure of the second type of test sample 1.1, referring to FIG. 6, is a flat sample and related similar structures thereof.

A structure of the third type of test sample 1.1, referring to FIG. 7, is a round bar sample and related similar structures thereof.

A structure of the fourth type of test sample 1.1, referring to FIG. 8, is a structural gradient sample and related similar structures thereof.

In the specific embodiment, arrangements of the following two test samples 1.1 are set to implement high-throughput testing of the mechanical properties of the materials.

First type: The material types of the test samples 1.1 are the same, and the mass of the mass blocks 1.1.1 is different.

Second type: The material types of the test samples 1.1 are different, and the mass of the mass blocks 1.1.1 is the same.

During the test of the mechanical properties of the materials, if the test sample 1.1 is installed according to the first type, due to the different mass of the mass blocks 1.1.1, centrifugal tensile stress applied to the test sample 1.1 is different at the same rotation speed, so that the mechanical properties of the material under both the same temperature and different stress may be tested in one test. If the test sample 1.1 is installed according to the second type, the material types are different, but the mass of the mass blocks 1.1.1 is the same. At the same rotation speed, the same centrifugal tensile stress is applied to the test samples 1.1 of different materials, so that the mechanical properties of the materials under both the same temperature and the centrifugal tensile stress may be tested in one test.

A process of the high-throughput testing implementation method in the disclosure is as follows.

First step: A spindle speed and a wheel radius of the centrifugal machine are determined according to the experimental conditions.

Second step: A size and a weight of the mass block 1.1.1 in the test sample 1.1 and a size and a geometric center of the standard section 1.1.2 are determined.

Third step: The test temperature and the centrifugal stress applied at the geometric center of the standard section 1.1.2 are determined, and then the rotation speed corresponding to the centrifugal stress at the geometric center of the standard section 1.1.2 is determined through finite element calculation.

Fourth step: The test sample 1.1 is installed in the slot 1.2 of the sample chuck 1, and a distance between the geometric center of the standard section 1.1.2 and a center of the main shaft of the centrifugal machine is determined. The test sample 1.1 is installed in each of the slots 1.2 of the sample chuck 1.

Fifth step: The temperature-controlling thermocouple 4.1 is welded and fixed at the geometric center of the standard section 1.1.2 of the test sample 1.1, and the temperature-controlling thermocouple 4.1 is connected to the temperature controlling system 4 through the temperature extension wire 4.2.

If strain is tested, a strain gauge is also welded and fixed at the geometric center of the standard section 1.1.2 of the test sample 1.1, and the strain gauge is connected to the data acquisition module 4.4 through a strain gauge extension wire to implement real-time acquisition of strain signals.

Sixth step: The induction heating system 2, the circulating water cooling system 3, and the temperature controlling system 4 are started. Through the temperature controlling system 4, the induction heating system 2 and the circulating water cooling system 3 are controlled to apply a temperature load to the test sample 1.1. After the temperature reaches a predetermined temperature, it may be kept warm for a period of 30 minutes.

In the sixth step, the induction heating system 2 is started to apply the temperature load to the test sample 1.1. Specifically, a constant and uniform temperature field is applied according to a uniform temperature heating mode, a periodically changing alternating temperature field is applied according to a periodically changing alternating temperature heating mode, and a temperature field with a fixed range and a gradually changing gradient is applied according to a temperature gradient heating mode.

Seventh step: The centrifugal machine is started, so that the main shaft of the centrifugal machine rotates and reaches the rotation speed corresponding to the centrifugal stress.

In the seventh step, the centrifugal machine is started to rotate the main shaft of the centrifugal machine. Specifically, the rotation speed is adjusted, so that different centrifugal tensile stress is applied to different positions of the test sample 1.1 along a direction of the centrifugal force, or a constant stress oi load is applied to different positions of the test sample 1.1 along the direction of the centrifugal force.

Eighth step: The temperature and the rotation speed is kept unchanged until the test sample 1.1 is pulled and broken.

During a process from when the main shaft of the centrifugal machine starts to rotate to when the test sample 1.1 is pulled and broken, data of the temperature changes and the stress changes are collected in real time through the temperature-controlling thermocouple 4.1 and the strain gauge as data for the high-throughput testing.

Ninth step: After the test sample 1.1 is pulled and broken, the induction heating system 2 and the temperature controlling system 4 are turned off, the centrifugal machine is powered off, and the test sample 1.1 is air-cooled to a room temperature.

The specific embodiment in the disclosure provides a variety of in-situ heating system modes for the high-throughput testing in a high-rotation speed environment, providing new experimental conditions for conducting tests of material properties under different temperatures and different speeds. The heating modes in the disclosure include, but are not limited, to the following situations.

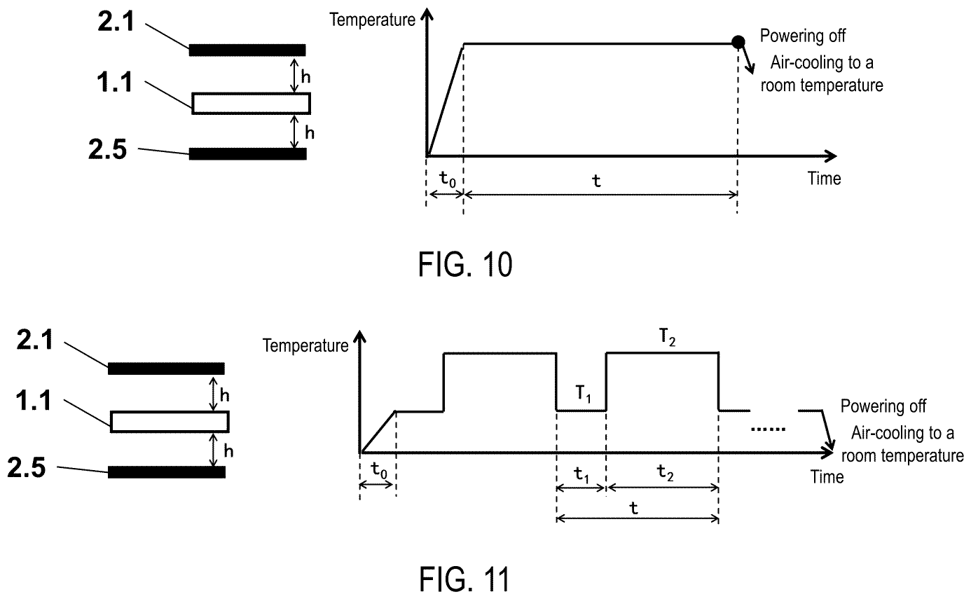

First heating mode: The uniform temperature heating mode is implemented on the standard section 1.1.2 of the test sample 1.1 at a high rotation speed, FIG. 10.

The experimental material type is the same. During the experiment, a distance h between the standard section 1.1.2 and the upper induction coil 2.1 and the lower induction coil 2.5 remains the same, and the heating power and heating frequency remain unchanged during time t. The constant and uniform temperature field is applied to the standard section 1.1.2.

Second heating mode: The periodically changing alternating temperature heating mode is implemented on the standard section 1.1.2 of the test sample 1.1 at a high rotation speed, FIG. 11.

The experimental material type is the same. During the experiment, the distance h between the standard section 1.1.2 and the upper induction coil 2.1 and the lower induction coil 2.5 remains the same. The heating frequency remains unchanged, but the heating power is changed periodically during the time t. The alternating temperature field of T1 is applied to the standard section 1.1.2 during the time t1, and T2 is applied during time t2.

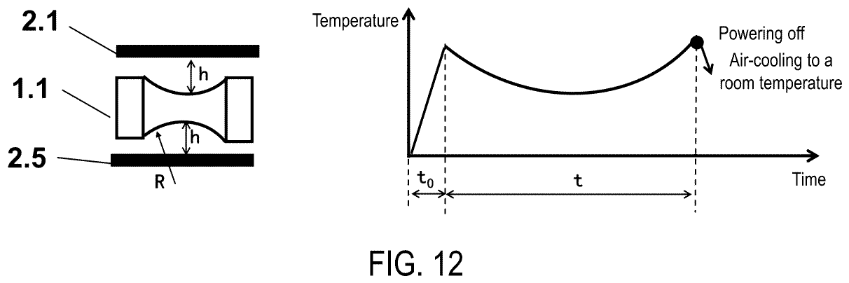

Third heating mode: A constant temperature gradient heating mode is implemented on the standard section 1.1.2 of the test sample 1.1 at a high rotation speed, FIG. 12.

The experimental material type is the same. The standard segment 1.1.2 of the test sample 1.1 is processed into an arc with a radius of R. During the experiment, the distance h between a lowest end of the arc of the standard segment 1.1.2 and the upper induction coil 2.1 and the lower induction coil 2.5 remains the same, and the heating power and the heating frequency remain unchanged during the time t. Since the distance from the arc-shaped standard section 1.1.2 to the induction coil 2.1 and the lower induction coil 2.5 changes continuously, according to principles of induction heating, under the same power and frequency conditions, the sample heating temperature is inversely proportional to the distance from the induction coil, thereby applying a constant temperature gradient to the standard section 1.1.2 of the test sample 1.1.

Based on the above heating modes, when the experimental material type is the same, and the weight of the mass block 1.1.1 is the same, the disclosure, in the process of implementing the high-throughput test of the mechanical properties of the metal materials, includes, but is not limited to the following situations.

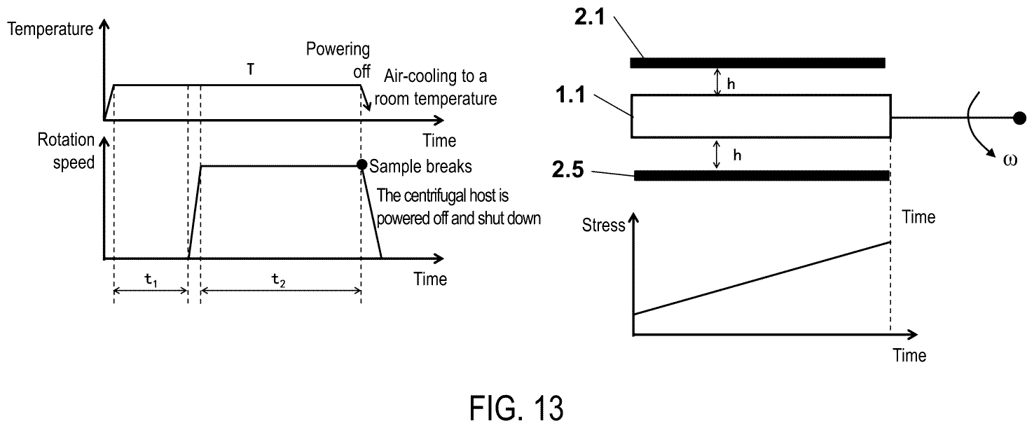

First type of high-throughput test experiment: The test sample 1.1 adopts the structure shown in FIG. 6. According to FIG. 13, when the mechanical properties of the material of the test sample 1.1 are tested under a constant speed and constant temperature, the induction heating system is first started to enable the temperature to reach T and maintain at t1. Then, the centrifugal machine is started to increase the speed to a predetermined speed and maintained at t2 until the sample breaks, and then the induction coil and the centrifugal machine are powered off at the same time to enable the sample to be air-cooled to the room temperature.

During the experiment, a constant temperature load is applied to the test sample 1.1, and different centrifugal tensile stress is applied to different positions of the test sample 1.1 along the direction of the centrifugal force, so that the sample under the effect of the high rotation speed and high temperature is always under the load effect (T, σi) (i refers to a cross section of the sample corresponding to a distance i from a centrifuge shaft, which is the same below). After the experiment, through analytical methods such as scanning electron microscopy and mechanical property testing methods such as nanoindentation, a relationship between the structure and properties of the sample under different (T, σi) load effects are analyzed and characterized to implement the high-throughput testing of the metal material properties under a high rotation speed and high temperature, which is used to study a relationship between the structure and properties of the materials under the constant temperature and different stress states.

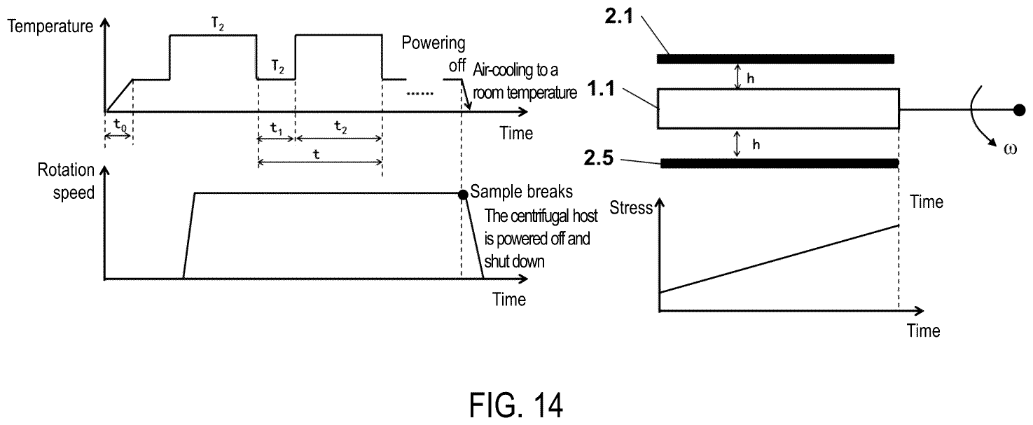

Second type high-throughput test experiment: The test sample 1.1 adopts the structure shown in FIG. 6. According to FIG. 14, when the material properties of the sample under constant speed-alternating heating are tested, the induction heating system is first started, heated to T1 within time t0, and then the centrifugal machine is started to increase the speed to a predetermined speed, and keep the speed constant. The temperature of the test sample 1.1 is maintained at T1 for t1, and then the temperature of the test sample 1.1 is reduced to T2 and maintained at t2 through the temperature controlling system 4. A periodic alternating heating mode is applied to the test sample 1.1 through a program setting of the temperature controlling system 4 until the sample breaks, and then the induction coil and the centrifugal machine are powered off at the same time to enable the sample to be air-cooled to the room temperature.

During the experiment, an alternating temperature load is applied to the test sample 1.1, and different centrifugal tensile stress is applied to different positions of the test sample 1.1 along the direction of the centrifugal force, so that the sample under the effect of the high rotation speed and high temperature is always under the (Ti, σi) load effect. After the experiment, through analytical methods such as scanning electron microscopy and mechanical property testing methods such as nanoindentation, a relationship between the structure and properties of the sample under different (Ti, σi) load effects are analyzed and characterized to implement the high-throughput testing of the metal material properties under a high rotation speed and high temperature, which is used to study a relationship between the fixed stress σi of the cross section i of sample and the structure and properties of the materials under alternating temperature conditions.

The third type of high-throughput test experiment:

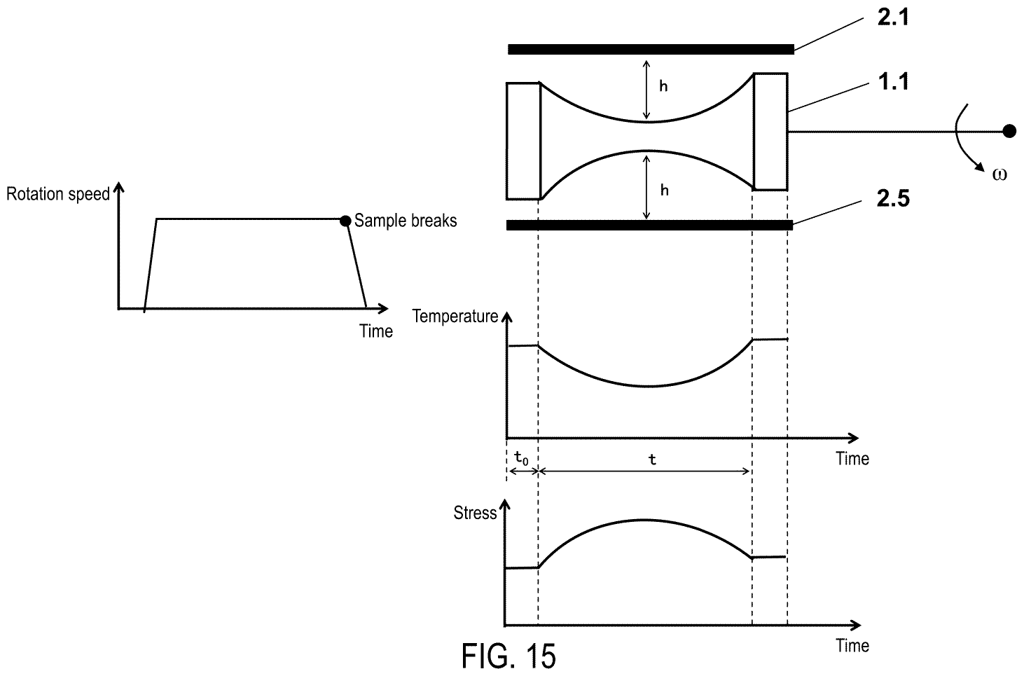

The test sample 1.1 adopts the structure shown in FIG. 2. According to FIG. 15, by keeping the rotation speed of the centrifugal machine constant, the constant stress σi is applied to the cross section i of the sample. During the high-speed rotation, the constant temperature Ti is applied to the cross section i of the sample by keeping the heating power and heating frequency of the induction heating system 2 constant until the sample breaks, and then the induction coil and the centrifuge are powered off at the same time to enable the sample to be air-cooled to the room temperature.

During the experiment, the constant temperature load Ti and the constant stress σi load are applied to the cross section i of the test sample 1.1, so that the cross section i of the test sample 1.1 under the high rotation speed and high temperature is always under the constant (Ti, σi) load effect. After the experiment, through analytical methods such as scanning electron microscopy and mechanical property testing methods such as nanoindentation, a relationship between the structure and properties of the sample under different (Ti, σi) load effects are analyzed and characterized to implement the high-throughput testing of the metal material properties under a high rotation speed and high temperature, which is used to study the fixed stress σi of the cross section i of sample and the structure and properties of the materials under the state at the constant temperature Ti.

What is claimed is:

1. An in-situ heating testing device for mechanical properties of a material under a high rotation speed and a high temperature, wherein:
the device comprises a sample chuck (1), an induction heating system (2), a circulating water cooling system (3), and a temperature controlling system (4);
the sample chuck (1) is coaxially installed on a main shaft of a centrifugal machine and rotates synchronously around the main shaft of the centrifugal machine,
the test sample (1.1) is installed on the sample chuck (1),
the induction heating system (2) is coaxially installed on the centrifugal machine and does not rotate around the main shaft of the centrifugal machine,
the induction heating system (2) is connected to the circulating water cooling system (3), and
the temperature controlling system (4) is connected to the circulating water cooling system (3) and the test sample (1.1) respectively.

2. The in-situ heating testing device for the mechanical properties of the material under the high rotation speed and the high temperature according to claim 1, wherein the sample chuck (1) comprises a disc body, a slot (1.2), and a flange (1.3), the flange (1.3) is coaxially installed at two ends of a center of the disc body, the disc body is coaxially fixedly connected to the main shaft of the centrifugal machine through the flange (1.3), a plurality of slots (1.2) are circumferentially disposed around the disc body, the slots (1.2) are arranged at intervals along a circumferential direction, and each of the slots (1.2) is used to install the one test sample (1.1).

3. The in-situ heating testing device for the mechanical properties of the material under the high rotation speed and the high temperature according to claim 1, wherein the test sample (1.1) is in a strip shape, comprising a mass block (1.1.1), a standard section (1.1.2), a load-bearing section (1.1.3), and an assembly tenon (1.1.4) connected in sequence, the mass block (1.1.1), the standard section (1.1.2), the load-bearing section (1.1.3), and the assembly tenon (1.1.4) are arranged in sequence along the strip shape of the test sample (1.1), and the assembly tenon (1.1.4) is embedded in the slot (1.2) of the sample chuck (1).

4. The in-situ heating testing device for the mechanical properties of the material under the high rotation speed and the high temperature according to claim 1, wherein one or both of a thermocouple and a strain gauge are arranged at a center of the standard section (1.1.2) of the test sample (1.1).

5. The in-situ heating testing device for the mechanical properties of the material under the high rotation speed and the high temperature according to claim 1, wherein the induction heating system (2) comprises an upper induction coil (2.1), an upper fixing plate (2.3), a lower induction coil (2.5), and a lower fixing plate (2.7); the upper fixing plate (2.3) and the lower fixing plate (2.7) are respectively fixed and arranged in parallel at upper and lower intervals, and the sample chuck (1) is arranged in an interval between the upper fixing plate (2.3) and the lower fixing plate (2.7); the annular upper induction coil (2.1) and lower induction coil (2.5) are respectively fixed to a bottom surface of the upper fixing plate (2.3) and a top surface of the lower fixing plate (2.7) through the upper induction coil insulation layer (2.2) and the lower induction coil insulation layer (2.6).

6. The in-situ heating testing device for the mechanical properties of the material under the high rotation speed and the high temperature according to claim 5, wherein the upper induction coil (2.1) and the lower induction coil (2.5) are respectively wrapped in inner cavities of the upper induction coil insulation layer (2.2) and the lower induction coil insulation layer (2.6), the inner cavities of the upper induction coil insulation layer (2.2) and the lower induction coil insulation layer (2.6) are communicated through a pipeline, and the upper induction coil insulation layer (2.2) and the lower induction coil insulation layer (2.6) are respectively fixed to the bottom surface of the upper fixing plate (2.3) and the top surface of the lower fixing plate (2.7) through an upper fixing screw rod (2.4) and a lower fixing screw rod (2.8).

7. The in-situ heating testing device for the mechanical properties of the material under the high rotation speed and the high temperature according to claim 1, wherein the circulating water cooling system (3) comprises a pipeline assembly arranged in the induction heating system (2) and a circulating water inlet pipe (3.1), a circulating water outlet pipe (3.3), a positive electrode (3.5), an inner insulation sleeve (3.6), a metal sleeve (3.7), a negative electrode (3.8), a copper tube (3.9), an insulating pressing sleeve (3.10), a fixing flange (3.11), an insulating pressing sleeve (3.14), a tightening round nut (3.15), a sealing member (3.18), an electrode insulating pressing sleeve (3.19), an external water outlet pipe (3.21), an external positive electrode plate (3.22), an external water inlet pipe (3.23), and an external negative electrode plate (3.24);
the copper tube (3.9) is sleeved with an insulating pressing sleeve (3.10) for insulation from the metal sleeve (3.7), and the insulating pressing sleeve (3.10) is sleeved with the metal sleeve (3.7);
a middle portion of the metal sleeve (3.7) is sealed and sleeved in a center hole of the fixing flange (3.11) through an insulating pressing sleeve (3.14) and a shaft sealing ring (3.13), the fixing flange (3.11) is fixed on an experimental chamber cover of the centrifugal machine, the copper tube (3.9), two ends of the insulating pressing sleeve (3.10), and the metal sleeve (3.7) are respectively fixed and sealed through the inner insulation sleeve (3.6) and the sealing member (3.18);
one end of the copper tube (3.9) passes through the inner insulation sleeve (3.6) to be coaxially connected to the circulating water outlet pipe (3.3), and the positive electrode (3.5) is arranged at an end portion after one end of the copper tube (3.9) passes through the inner insulation sleeve (3.6);
the external positive electrode plate (3.22) is electrically connected to the copper tube (3.9) through the electrode insulating pressing sleeve (3.19), so that the positive electrode (3.5) is directly electrically connected to the external positive electrode plate (3.22) through the copper tube (3.9);
the other end of the copper tube (3.9) is connected to the external water outlet pipe (3.21), so that the circulating water outlet pipe (3.3) circulates directly through the copper tube (3.9) and the external water outlet pipe (3.21);
an annular pipe gap is provided between the insulating pressing sleeve (3.10) and the metal sleeve (3.7) for use as a water inlet channel, one end of the water inlet channel is communicated and connected to the circulating water inlet pipe (3.1) through a metal pipe, the negative electrode (3.8) is disposed near an end of the circulating water inlet pipe (3.1);
the external negative electrode plate (3.24) is electrically connected to the metal sleeve (3.7) through the tightening round nut (3.15), so that the negative electrode (3.8) is electrically connected to the external negative electrode plate (3.24) through the metal pipe and the metal sleeve (3.7) in sequence;
a through groove is disposed on one end of a pipe wall of the metal sleeve (3.7) connected to the sealing member (3.18), and the through groove is in fluid communication with the external water inlet pipe (3.23), so that the circulating water inlet pipe (3.1) is in fluid communication with the external water inlet pipe (3.23) through the metal pipe, the water inlet channel, and the through groove;
the pipeline assembly comprises a heating water inlet pipe (2.11), a water inlet pipe sealing sleeve (2.12), a heating water outlet pipe (2.13), and a water outlet pipe sealing sleeve (2.14); one ends of the heating water inlet pipe (2.11) and the heating water outlet pipe (2.13) are connected to the circulating water inlet pipe (3.1) and the circulating water outlet pipe (3.3) through the water inlet pipe sealing sleeve (2.12) and the water outlet pipe sealing sleeve (2.14) respectively, the other ends of the heating water inlet pipe (2.11) and the heating water outlet pipe (2.13) are respectively connected to inner cavity environments where the upper induction coil (2.1) and the lower induction coil (2.5) in the induction heating system (2) are located, and the inner cavity environments where the upper induction coil (2.1) and the lower induction coil (2.5) are located are connected to each other.

8. The in-situ heating testing device for the mechanical properties of the material under the high rotation speed and the high temperature according to claim 7, wherein the external water outlet pipe (3.21) and the external water inlet pipe (3.23) are respectively connected to a water inlet and a water outlet of a circulating water machine; the positive electrode (3.5) and the negative electrode (3.8) are electrically connected to the upper induction coil (2.1) and the lower induction coil (2.5) respectively, and the external positive electrode plate (3.22) and the external negative electrode plate (3.24) are connected to positive and negative electrodes of an external power source respectively.

9. The in-situ heating testing device for the mechanical properties of the material under the high rotation speed and the high temperature according to claim 1, wherein the temperature controlling system (4) comprises a thermocouple (4.1), a thermocouple extension wire (4.2), a high-speed slip ring (4.3), a data acquisition module (4.4), a data conversion and transmission module (4.6), and a high-frequency AC power supply cabinet (4.7); the thermocouple (4.1) is fixedly disposed on a surface of the test sample (1.1) corresponding to the upper induction coil (2.1) and the lower induction coil (2.5) of the induction heating system (2); the thermocouple (4.1) is connected to the data acquisition module (4.4) through the thermocouple extension wire (4.2) and the high-speed slip ring (4.3), the data acquisition module (4.4) is communicatively connected to the high-frequency AC power supply cabinet (4.7) through the data conversion transmission module (4.6), and the high-frequency AC power supply cabinet (4.7) is electrically connected to the external positive electrode plate (3.22) and the external negative electrode plate (3.24) of the circulating water cooling system (3).

10. A high-throughput testing method applied to the testing device according to claim 1, wherein
first step: determining a spindle speed and a wheel radius of the centrifugal machine according to experimental conditions;
second step: determining a size and a weight of the mass block (1.1.1) in the test sample (1.1), and a size and a geometric center of the standard section (1.1.2);
third step: determining a test temperature and centrifugal stress applied at the geometric center of the standard section (1.1.2), and then determining a rotation speed corresponding to the centrifugal stress at the geometric center of the standard section (1.1.2);
fourth step: installing the test sample (1.1) in the slot (1.2) of the sample chuck (1), and determining a distance between the geometric center of the standard section (1.1.2) and a center of the main shaft of the centrifugal machine;
fifth step: fixing the upper temperature-controlling thermocouple (4.1) at the geometric center of the standard section (1.1.2) of the test sample (1.1);
fixing a strain gauge at the geometric center of the standard section (1.1.2) of the test sample (1.1), and connecting the strain gauge to the data acquisition module (4.4) through a strain gauge extension wire;
sixth step: starting the induction heating system (2), the circulating water cooling system (3), and the temperature controlling system (4), and through the temperature controlling system (4), controlling the induction heating system (2) and the circulating water cooling system (3) to apply a temperature load to the test sample (1.1);
seventh step: when the temperature reaches a set temperature, starting the centrifugal machine such that the main shaft of the centrifugal machine rotates and the rotation speed reaches a set rotation speed condition;
eighth step: keeping the temperature and the rotation speed unchanged until the test sample (1.1) is pulled and broken;
during a process from when the main shaft of the centrifugal machine starts to rotate to when the test sample (1.1) is pulled and broken, data of temperature changes and stress changes are collected in real time through the temperature-controlling thermocouple (4.1) and the strain gauge as data for the high-throughput testing to obtain curves of temperature vs. time and strain vs. time in a process of high-throughput mechanical property testing of a material;
ninth step: after the test sample (1.1) is pulled and broken, turning off the induction heating system (2) and the temperature controlling system (4), powering off the centrifugal machine, and air-cooling the test sample (1.1) to a room temperature.

11. The high-throughput testing method according to claim 10, wherein in the sixth step, the induction heating system (2) is started to apply the temperature load to the test sample (1.1), specifically, a constant and uniform temperature field is applied according to a uniform temperature heating mode, a periodically changing alternating temperature field is applied according to a periodically changing alternating temperature heating mode, and a temperature field with a fixed range and a gradually changing gradient is applied according to a temperature gradient heating mod.

12. The high-throughput testing method according to claim 10, wherein in the seventh step, the centrifugal machine is started to rotate the main shaft of the centrifugal machine, specifically, the rotation speed is adjusted, so that different centrifugal tensile stress is applied to different positions of the test sample (1.1) along a direction of the centrifugal force, or a constant stress σi load is applied to different positions of the test sample (1.1) along the direction of the centrifugal force.

13. The high-throughput testing method according to claim 10, wherein in the seventh step, the centrifugal machine is started to rotate the main shaft of the centrifugal machine, and the rotation speed reaches a fixed rotation speed corresponding to the centrifugal stress.
